(19) United States
(12) Patent Application Publication
(10) Pub. No.: US 2025/0328134 A1
(43) Pub. Date: Oct. 23, 2025

(54) VEHICLE COMMUNICATION CONTROL DEVICE AND METHOD

(71) Applicant: LG UPLUS CORP, Seoul (KR)

(72) Inventor: Sung Min KIM, Seoul (KR)

(21) Appl. No.: 19/257,355

(22) Filed: Jul. 1, 2025

Related U.S. Application Data
(63) Continuation of application No. PCT/KR2024/000005, filed on Jan. 2, 2024.

(30) Foreign Application Priority Data
Jan. 3, 2023 (KR) 10-2023-0000820
May 11, 2023 (KR) 10-2023-0061370
Sep. 13, 2023 (KR) 10-2023-0121475
Dec. 15, 2023 (KR) 10-2023-0183309

(51) Int. Cl. G05D 1/225; B60W 60/00

(52) U.S. Cl. CPC G05D 1/225; B60W 60/001; B60W 2556/45; B60W 2756/10

(57) ABSTRACT

A vehicle communication control device capable of remote driving is disclosed. The vehicle communication control device capable of remote driving includes an autonomous vehicle driven under driving control according to signals, a remote driving sensor unit that receives sensor data from at least one sensor located inside and outside the autonomous vehicle, a network status processor that calculates a delay time for a network path between the vehicle and a server device and generates target bit rate information based on the delay time, a data encoder that encodes remote environment data including the sensor data based on the target bit rate information, and a transmission unit that transmits the encoded data to a remote driving control server device.

This application is a continuation of PCT/KR2024/000005 filed on Jan. 2, 2024, which claims the benefit of Korean Patent Application No. 10-2023-0000820, filed on Jan. 3, 2023, Korean Patent Application No. 10-2023-0061370, filed on May 11, 2023, Korean Patent Application No. 10-2023-0121475, filed on Sep. 13, 2023, and Korean Patent Application No. 10-2023-0183309, filed on Dec. 15, 2023, each of which is hereby incorporated by reference in its entirety.

### BACKGROUND

### Field

The present disclosure relates to a communication control device and method for autonomous vehicles, and more specifically, to a method of controlling autonomous driving while stably maintaining cellular communication in a vehicle-mounted network device, a method of defining operating states considering various situations of a remote driving control center in a situation where a tele-operated vehicle transmits a request for a remote driving service, and setting an operating state of the tele-operated vehicle accordingly, and a device therefor.

### Discussion of the Related Art

Recently, much research has been conducted on technologies for efficiently collecting sensor data related to vehicles through vehicle communication and transmitting the same to an external server.

Referring to prior research related to such systems, the key to collecting data generated in vehicles is overcoming the characteristics of vehicle data (heterogeneous) and network characteristics (limited network resources), and therefore, various studies related thereto are being conducted.

In particular, among such studies, monitoring a network situation of an autonomous vehicle and appropriately processing and transmitting data related to autonomous driving in response to monitoring results is a very important field.

Conventional research in the relevant technical field has been limited to data transmission in vehicles. For example, the network speed is measured only using the network processing technology (such as channel bonding) installed in vehicles and used for data transmission.

However, the problem with the conventional methods is that when many autonomous vehicles simultaneously transmit large amounts of data such as video/lidar images to a server via 5G uplink in real time, network congestion is aggravated, impacting other devices using general 5G communication in the area. In particular, autonomous vehicles transmit vast amounts of data, consuming all available 5G uplink bandwidths, and only when the network becomes unavailable, data communication is stopped. At this time, the network in the area is already paralyzed, and there is a problem that safety/convenience issues become serious.

In particular, data transmission is mainly concerned with a single autonomous vehicle transmitting data, and since data is transmitted through compression, channel bonding, etc., there was no concern about whether all autonomous vehicles registered with the service can transmit data at the same time from the perspective of the entire service (control). In other words, there was no concern about the current mobile network becoming unavailable due to data transmission by autonomous vehicles in service.

In addition, autonomous driving described above can be expanded to remote driving. Remote driving refers to a service in which a driver at a control center controls an autonomous vehicle through remote driving when safe autonomous driving is difficult. In this case, a large amount of data needs to be transmitted to the server, and in order for remote driving to be performed safely, real-time transmission of data must be guaranteed. To this end, technical tasks of avoiding paralysis of the network connecting autonomous vehicles and the server and constantly measuring the status of the network to prevent communication interruption are required.

An autonomous vehicle refers to a vehicle that can travel itself without the operation of a driver or passenger. In addition, as communication technology advances, a large amount of data can be transmitted rapidly and thus more diverse services can be provided through wireless communication systems.

Currently, autonomous vehicles are not yet at a level where they can travel without problems in environments such as heavy rain, heavy snow, thick fog, or unexpected situations. When Google received a driverless car license in Nevada, the inspector pointed out problems with adapting to various weather conditions and environments such as unpaved roads.

In order to supplement address such problems of autonomous vehicles, research is actively being conducted on a remote control autonomous driving control system capable of remotely monitoring and operating autonomous vehicles based on information on traveling locations of autonomous vehicles, location information of the autonomous vehicles, and various types of sensing information collected by the autonomous vehicles, that is, remote driving. As various transportation methods and services become popular and expanded, remote control of autonomous vehicles is expected to become a very important in transportation.

According to current remote driving technology, an autonomous vehicle equipped with the remote driving function transmits a request for remote driving to the control center in situations where the autonomous vehicle cannot perform autonomous driving, and receives driving control information from a remote driver in the remote driving control center.

However, when an autonomous vehicle transmits a request for remote driving, if a remote driver in the remote driving control center cannot respond to the request, the vehicle may not be able to receive the remote driving service.

In addition, if the remote driving control system uses different control and management methods depending on remote driving service providers, the remote driving services that can be provided by the remote driving control center are limited.

### SUMMARY

The present disclosure is to address the above-mentioned problems and/or disadvantages, and an aspect of the present disclosure is to provide a vehicle communication control device that can be installed in an autonomous vehicle capable of remote driving, and can monitor a network status and thus control transmission of autonomous driving and/or remote driving data, and a vehicle communication control method.

In another aspect of the present disclosure for solving the above-described problem, the present disclosure proposes a method of defining operating states considering various situations of a remote driving control center in a situation where a tele-operated vehicle transmits a request for a remote driving service, and setting an operating state of the tele-operated vehicle accordingly, and a device therefor.

Specifically, in defining an operating state of a tele-operated vehicle, the present disclosure proposes defining and operating an operation mode of a tele-operated vehicle such that the vehicle can be provided with an appropriate remote driving service even when a remote driver in the remote driving control center cannot respond to a request for remote driving when the vehicle transmits the request.

In addition, the present disclosure proposes a method in which a remote driving control center can efficiently provide a remote driving service by using a control method that is commonly standardized among remote driving service providers in a remote driving control system.

In addition, as specific embodiments of the present disclosure, specific scenarios in which a monitoring mode/assistant driving mode/direct driving mode can be utilized are presented, and an operation method for each scenario is proposed.

The aspects to be solved in the present disclosure are not limited to the aspects mentioned above, and other aspects not mentioned can be clearly understood by a person having ordinary knowledge in the technical field to which the present disclosure belongs from the description below.

According to one aspect of the present disclosure, a remote driving server device for controlling a vehicle capable of remote driving includes a data decoder configured to decode remote environment data received from a remote driving target vehicle device, a network delay predictor configured to calculate a network delay time for a network path between the vehicle device and the server device and to transmit information on the network delay time to the vehicle device, and a remote driving driver's seat configured to generate a remote driving control instruction for the vehicle.

The remote driving server device may further include a remote driving ECU configured to receive a remote driving instruction from the remote driving driver's seat and to generate remote driving control information based on the remote driving instruction, and a transmission unit configured to transmit the remote driving control information to the vehicle device.

The network delay predictor may include a delay time calculation unit configured to receive a probe packet for network status analysis from the vehicle device and to calculate a delay time for a network path between the server device and the vehicle, and a delay information transmission unit configured to generate network delay information based on the calculated delay time and to transmit the network delay information to the vehicle.

The network delay predictor may further include a control information reception unit configured to receive control information for remote driving, and a storage configured to store the calculated delay time and the control information.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram showing a structure of a vehicle communication control system according to an embodiment of the present disclosure;

FIG. 2 is a block diagram schematically showing a configuration of an autonomous vehicle including a vehicle communication control device according to an embodiment of the present disclosure;

FIG. 3 is a conceptual diagram schematically showing a 5G network environment in which there are multiple autonomous vehicles of FIG. 2;

FIG. 4 is a detailed block diagram specifically showing structures of data control units of a vehicle and a server of FIG. 1;

FIG. 5 is a flowchart showing a vehicle communication control method according to an embodiment of the present disclosure;

FIG. 6 is a block diagram showing a structure of a vehicle communication control system for remote driving according to an embodiment of the present disclosure;

FIG. 7 is a block diagram showing a structure of a network status processing unit according to an embodiment of the present disclosure;

FIG. 8 is a block diagram showing a structure of a network delay predictor according to an embodiment of the present disclosure;

FIG. 9 is a flowchart showing a vehicle communication control method for remote driving according to an embodiment of the present disclosure;

FIG. 10 is a diagram illustrating components of a remote driving (ToD) system;

FIG. 11 is a diagram illustrating operating states of a ToV for providing a standardized ToD service;

FIG. 12 is a diagram illustrating a configuration of a ToD system according to an embodiment of the present disclosure;

FIG. 13 is a diagram for specifically describing an operation method in a ToC operating state according to an embodiment of the present disclosure;

FIG. 14 is a diagram showing a configuration of a remote driving system according to an embodiment of the present disclosure; and

FIG. 15 is a diagram showing mode switching states in a remote driving system according to another embodiment of the present disclosure.

### DETAILED DESCRIPTION

Hereinafter, embodiments of the present disclosure will be described in detail with reference to the attached drawings such that those skilled in the art can easily practice the disclosure. However, the present disclosure can be implemented in various different forms and is not limited to the embodiments described herein. In addition, in order to clearly explain the present disclosure, parts that are not related to the description are omitted in the drawings, and similar parts are assigned similar drawing reference numerals throughout the specification.

Throughout the specification, when a part is said to “include” a certain component, this does not mean that other components are excluded, but that other components can be further included, unless specifically stated otherwise.

In the following description, remote driving may be referred to as “Tele-operated Driving (ToD)” or simply “Remote Driving (RD)”. In addition, in terms of a system that provides remote driving to a vehicle equipped with a low speed autonomous driving system (LSADS), it may also be referred to as Remote Support (RS)-LSADS.

However, in the following description, for the sake of unification of terminology, remote driving that is not limited to low-speed autonomous vehicles will be referred to as ToD, and remote driving specific to low-speed autonomous vehicles will be referred to as RS-LSADS.

Hereinafter, a preferred embodiment of the present disclosure will be described in more detail with reference to the attached drawings. In order to facilitate overall understanding of the present disclosure in describing the present disclosure, the same reference numerals are used for the same components in the drawings, and redundant descriptions of the same components are omitted. In addition, it is assumed that multiple embodiments are not mutually exclusive and that some embodiments can be combined with one or more other embodiments to form new embodiments.

### Vehicle Communication Control System, Device, and Method

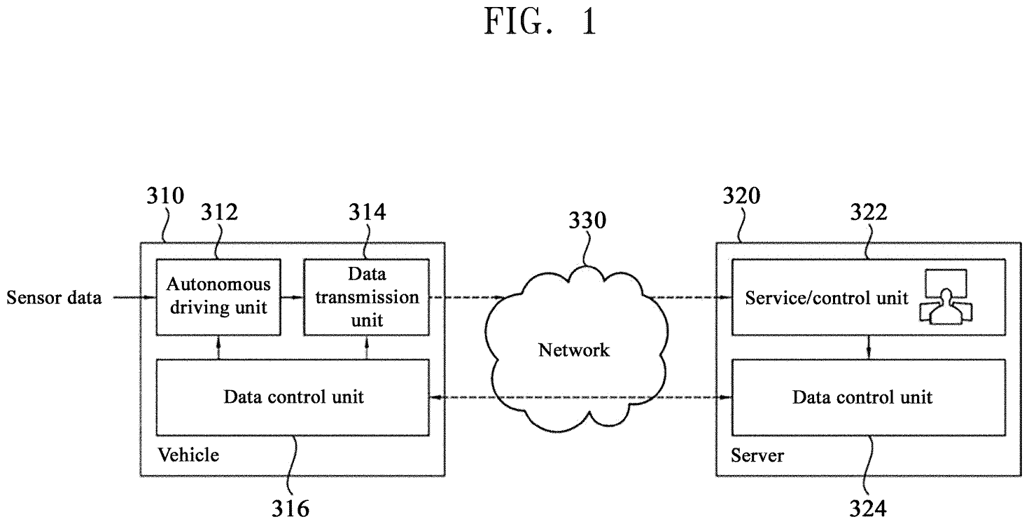

FIG. 1 is a block diagram showing a structure of a vehicle communication control system according to an embodiment of the present disclosure. As illustrated in FIG. 1, the vehicle communication control system according to an embodiment of the present disclosure may include a vehicle 310 and a server device 320.

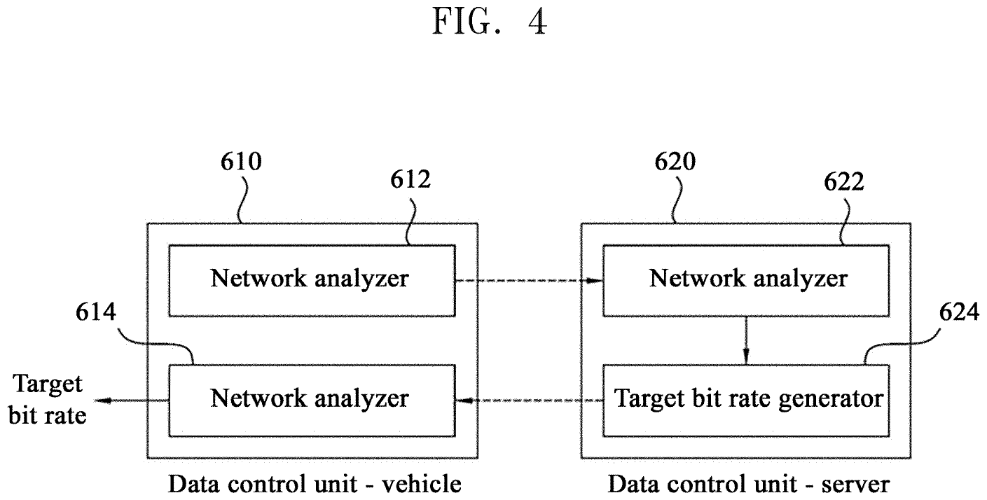

Referring to FIG. 1, the vehicle 310 may include an autonomous driving unit 312, a data transmission unit 314, and a data control unit 316. The autonomous driving unit 312 has an autonomous vehicle driving function. The autonomous driving unit 312 receives sensor data from a number of sensors provided inside or around the vehicle and utilizes the same for autonomous driving. At this time, the sensors detect various types of information related to the surroundings of the vehicle, such as the front, rear, and side of the vehicle, and driving or safety of the vehicle. The autonomous driving unit 312 performs autonomous driving using various types of sensor data detected in real time. The sensors and operations related to autonomous driving will be described in more detail below with reference to FIG. 4.

The data transmission unit 314 appropriately controls the bit rate of transmission target data associated with the vehicle based on a control signal of the data control unit 316 and transmits the same to the server 320 through a network 305. The data transmission unit 314 includes a communication module for wired or wireless communication.

The data control unit 316 communicates with the data control unit 324 on the server side and generates a packet for measuring a network status. Then, the data control unit 316 receives target bit rate information determined by the data control unit 324 on the server side, generates a signal for controlling the bit rate of the transmission target data associated with the vehicle, and provides the same to the data transmission unit 314.

The network 330 is a communication network for allowing data to be exchanged between the autonomous vehicle 310 and the server 320. According to an embodiment of the present disclosure, the network 330 may be implemented as various types of wireless networks such as 5G, 6G, 4G, LTE, 3G, and WiBro. Preferably, the network 330 may be implemented as a 5G network. However, even if the network 330 is configured as a 5G network or an entity associated therewith (e.g., gNodeB), it will be apparent to those skilled in the art that the network 330 can be implemented as a 6G network, a 4G network, a 3G network or an entity associated therewith (eNodeB, NodeB).

The server 320 may be an Internet data collection server that collects data via the Internet. The server 320 may be called a data collection server, a control server, or a service server. The server 350 may include a service/control unit 322 that receives data transmitted from a vehicle and performs services such as autonomous driving-related positioning and control, and the data control unit 324 that controls the bit rate of data from the vehicle 310 through network status analysis.

In addition, although not shown in the drawing, the service/control unit 322 may perform functions of collecting data related to autonomous driving of the autonomous vehicle 310 and controlling autonomous driving of a plurality of vehicles 310 while transmitting appropriate information such that autonomous driving can be performed smoothly. The service/control unit 322 may be implemented as a separate server device.

The data control unit 324 includes a device that monitors the status of the network. For example, the data control unit 324 may include a network monitoring device provided by a network operator. This may include a backhaul monitoring device, a core network monitoring device, etc. The data control unit 324 predicts and analyzes the current network status on a packet path based on a packet transmitted from the data control unit 324 on the vehicle side. Then, the data control unit 324 may generate information on communication-related parameters optimized for data communication with the vehicle 310 (e.g., target bit rate information) based on the analysis result and provide the information to the data control unit 316 on the vehicle side via the network 330. Like the service/control unit 322, the data control unit 324 may also be implemented as an independent device.

In the present disclosure, the data control units 316 and 324 may be referred to as a vehicle communication control device.

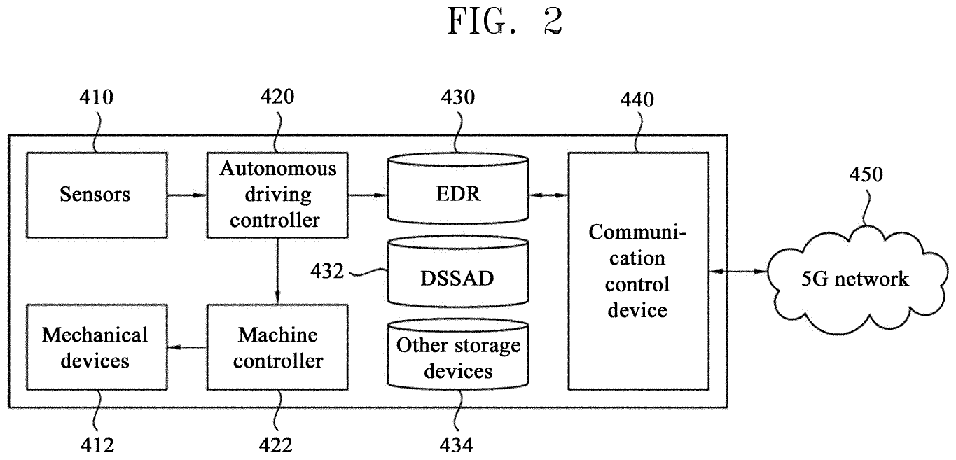

FIG. 2 is a block diagram schematically showing a configuration of an autonomous vehicle including a vehicle communication control device according to an embodiment of the present disclosure. As illustrated in FIG. 2, an autonomous vehicle according to an embodiment of the present disclosure may include sensors 410, mechanical devices 412, an autonomous driving controller 420, a machine controller 422, an event data recorder (EDR) 430, a data storage system for autonomous driving (DSSAD) 432, other storage devices 434, and a communication control device 440.

Referring to FIG. 2, the sensors 410 are installed in a vehicle or around the vehicle and detect sensing data used as data for autonomous driving. The sensors 410 include a plurality of cameras, a plurality of LiDARs, a plurality of radars, etc. Most thereof are composed of multiple sensors that produce large amounts of data.

The sensors 410 may output raw data and also output various recognition results processed from the raw data. Additionally, the sensors 410 include sensors of various electronic control units (ECUs) installed in the vehicle. Information generated by the sensors of these ECUs may include information on various vehicle operating states such as a vehicle speed, tire pressure, steering angle, air-bag opening/closing, brake force, and electronic stability control (ESC) operation.

The autonomous driving controller 420 performs path setting, location recognition, object recognition, and risk determination using sensor data generated by the sensors 410, instructs the machine controller 422, and controls the mechanical devices 412 based thereon.

Various types of sensor data generated and control signals related to autonomous driving are stored in a storage such as the EDR 432, the DSSAD 434, and other storage devices 436.

At least some of the sensor data (which may be referred to as vehicle data) stored in the storage device may be reconstructed through the communication control device 440 and transmitted to an external device (e.g., an autonomous driving control server) via a 5G network 450.

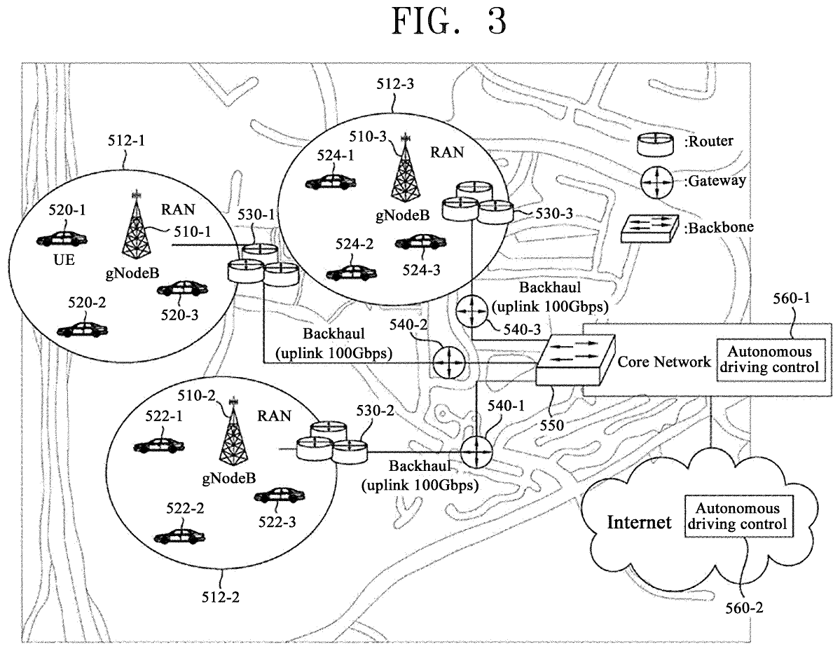

FIG. 3 is a conceptual diagram schematically illustrating a 5G network environment in which there are multiple autonomous vehicles of FIG. 2.

Referring to FIG. 3, each of autonomous vehicles 520-1 to 520-3, 522-1 to 522-3, and 524-1 to 524-3 includes a communication control device that controls communication, and the communication control device securely processes communication data and connects components inside the vehicle to an external device outside the vehicle. The communication control device may transmit vehicle data to a specific server upon request from the autonomous driving controller or an external device, and may not transmit vehicle data upon request.

In general, communication devices have functions such as channel bonding, channel coding, data bit rate control, compression control, network coding, and network optimization for data communication, and transmit vehicle data to a server using these functions.

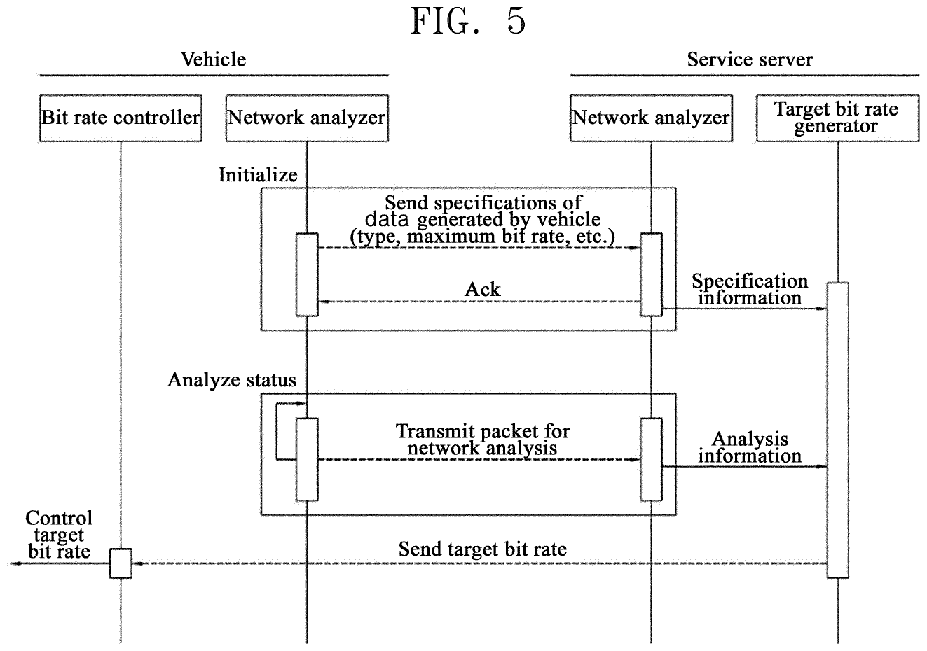

Autonomous vehicles (general passenger vehicles, vehicles for government offices, local government special vehicles, disabled transport vehicles, delivery robots, etc.) are currently being tested in a small number of sections, but in the future, many vehicles will travel in various places in the city center as shown in FIG. 5. However, in the city center, not only autonomous vehicles but also video services for ordinary people are increasing explosively, and there are more mobile devices, and they will competitively use 5G networks (uplink 10 Gbps, downlink 20 Gbps) to transmit data more rapidly. In such an environment, in order for autonomous driving to be properly performed, communication control for vehicle data transmission that adaptively responds to the network environment may be required.

Referring to FIG. 3, the autonomous vehicles 520-1 to 520-3, 522-1 to 522-3, and 524-1 to 524-3 may be located on a 5G network. The autonomous vehicles 520-1 to 520-3, 522-1 to 522-3, and 524-1 to 524-3 are connected to the network through base stations (gNodeB) 510-1, 510-2, and 510-3 in specific areas through radio access networks (RANs).

That is, the individual base stations 510-1, 510-2, and 510-3 control wireless communication within cells 512-1, 512-2, and 512-3 controlled thereby through the RANs and manages wireless communication of vehicles located within the individual cells. The vehicles 520-1 to 520-3 are located in cell 1 512-1, the vehicles 522-1 to 522-3 are located in cell 2 512-2, and the vehicles 524-1 to 524-3 are located in cell 3 512-3, and thus each cell controls wireless communication of the vehicles located therein.

Vehicle data wirelessly transmitted to the base stations 510-1, 510-2, and 510-3 may be connected to routers 530-1, 530-2, and 530-3 in a wired manner, and may be connected to a core network (CN) 550 (which may be referred to as an upper network, backbone network) via gateways 540-1, 540-2, and 540-3. The core network 550 is connected to the Internet, and control servers 560-1 and 560-2 for autonomous driving control may be provided in at least one of the core network 550 or the Internet to control autonomous driving of the vehicles 520-1 to 520-3, 522-1 to 522-3, and 524-1 to 524-3 within the RANs. Here, the routers 530-1, 530-2, and 530-3 and the gateways 540-1, 540-2, and 540-3 are included in the backhaul technology.

At this time, the bandwidth of the 5G network transmitted through each backhaul is 100 Gbps. In other words, as more user equipment (UE) is connected to the RAN, the more the network throughput decreases, and as the throughput approaches the bandwidth of 100 Gbps, the communication status becomes increasingly unstable.

As illustrated in FIG. 3, the control servers 560-1 and 560-2 for controlling the autonomous vehicles 520-1 to 520-3, 522-1 to 522-3, and 524-1 to 524-3 may be configured in the core network 550 configured by each telecommunications company for fast and safe communication, or may be installed in the general Internet, like the telematics services of OEMs currently manufacturing each vehicle.

Basically, in data transmission technology for autonomous vehicles, the server may be connected to the Internet. In such cases, a vehicle data communication control device installed in a vehicle mainly uses channel bonding to secure higher throughput, and the server connected to the Internet only serves to receive and process data. That is, even if the throughput approaches the bandwidth allowed in a specific RAN area (uplink 100 Gbps in the case of 5G), data communication cannot be controlled, and thus communication failure is detected only after the throughput exceeds the bandwidth or the latency increases.

This phenomenon can paralyze communications in the relevant RAN area, and as 5G NR is introduced and numerous 5G applications that transmit large amounts of data using uplink are created, this problem can become even more serious.

In addition, since different numbers of vehicles 520-1 to 520-3, 522-1 to 522-3, and 524-1 to 524-3 are connected to the RANs, the throughput within each RAN may be different. In one RAN, multiple autonomous vehicles 520-1 to 520-3, 522-1 to 522-3, and 524-1 to 524-3 equipped with a communication control function according to an embodiment of the present disclosure may travel autonomously, and may transmit a large amount of data (data from cameras, lidars, or other sensors) to the control service center. At this time, the throughput of each RAN may be different depending on the type and volume of data being transmitted between the vehicles connected to the RAN and the control center.

Therefore, it is important to provide the communication control device according to an embodiment of the present disclosure to each of the vehicles 520-1 to 520-3, 522-1 to 522-3, and 524-1 to 524-3 and the service (control) server to control network throughput. In particular, it is desirable to actively measure the network status between the vehicles and the service server for autonomous vehicles registered with the service, thereby controlling data generated by multiple autonomous vehicles simultaneously connected to the server such that all autonomous vehicles can autonomously travel safely.

FIG. 4 is a detailed block diagram specifically showing the structure of the data control unit on the vehicle and server sides of FIG. 1. As shown in FIG. 4, the data control unit 610 on the vehicle side may include a network analyzer 612 and a bit rate controller 614, and the data control unit 620 on the server side may include a network analyzer 622 and a target bit rate generator 624.

Referring to FIG. 4, the network analyzer 612 of the vehicle data control unit 610 generates a packet for unidirectional packet transmission from the autonomous vehicle to the server in order to measure a network status.

The bit rate controller 614 of the vehicle data control unit 610 transmits a signal for increasing or decreasing a data generation and/or transmission bit rate of the autonomous driving system based on information on a target bit rate received from the server.

The network analyzer 622 of the server data control unit 620 receives the packet transmitted from the network analysis unit 612 of the vehicle and performs a function of predicting and analyzing the network status on a packet path.

The target bit rate generator 624 of the server data control unit 620 increases or decreases the current bit rate based on the network status analyzed by the network analyzer 622 to generate a target bit rate and sends the target bit rate to the data control unit 610 of the vehicle.

FIG. 5 is a flowchart showing a vehicle communication control method according to an embodiment of the present disclosure.

Referring to FIG. 5, the vehicle communication control method according to an embodiment of the present disclosure includes (1) an initialization operation, (2) an operation of analyzing a network status, and (3) an operation of controlling the amount of data generated from the vehicle. The entire sequence is as follows.

First, in the (1) initialization phase, the network analyzer of the vehicle transmits the data specifications of the vehicle to the server. The data specifications of the vehicle may include information on the types of data (data from a camera, a lidar, and a car sensor, driver information, etc.) transmitted from the vehicle to the service server (control server), the amount of data, and the maximum bit rate. Upon reception of the information, the network analyzer of the server transmits an acknowledgement signal ACK to the vehicle. Then, the received information on the specifications is transmitted from the network analyzer of the server to the target bit rate generator.

Second, in the (2) status analysis phase, upon reception of the acknowledgement signal ACK, the network analyzer of the vehicle starts to periodically transmit a packet for network status analysis to the service server. The server analyzes the received packet and predicts and analyzes the network status based on information such as packet delay between the vehicle and the server. Here, an active network monitoring method may be utilized.

More specifically, the network analyzer extracts information on the time at which the packet arrives at the server from the vehicle. Additionally, the network analyzer 622 may calculate a request time, a latency, a response time, etc. based on a response packet for the network analysis packet, the arrival time of vehicle data transmitted based on the response packet, etc. In one example, a round trip time (RTT) information of the packet on the network between the vehicle and the server is calculated. Assuming a basic synchronization scenario, the vehicle may initially transmit a synchronization signal SYN, and the server may receive the same and transmit the synchronization signal and an acknowledgement signal ACK together in response to the received synchronization signal. Then, the vehicle that has received the same may transmit an acknowledgement signal ACK in response to the signals from the server. Transmission and reception of these three signals can be called 3-way handshake. Based thereon, indices related to the various network performance metrics described above can be calculated.

In addition, based on source IDs of packets of a plurality of vehicles currently transmitted to the service server, the server may determine a region (especially a cell) from which the packets are transmitted, and calculate information related to allocation of a network bandwidth for each region. In addition, when the server is unable to respond to a request, information on the number of sessions waiting for a response (wait) may also be calculated based on the number of sessions in this state. Further, UPS (Users Per Second) information indicating the number of vehicle terminals that can be connected per second, CPS (Connections Per Second) information indicating the number of new sessions connected per second, and TPS (Transactions Per Second) information indicating the number of transactions occurring per second may also be calculated. Furthermore, BPS (Bits Per Second) information by region may also be calculated.

Finally, in the (3) data amount control phase, the target bit rate generator of the server generates a network target bit rate of the relevant vehicle based on the data specification information generated by the vehicle and the above-mentioned network analysis information, and transmits the same to the bit rate controller of the vehicle. If the data specifications generated by the vehicle include of a large amount of data such as camera or lidar sensing signals (image signals), and the network status of the cell where the vehicle is currently located is not good, it is desirable to generate a relatively low target bit rate compared to other cases.

The target bit rate generated by the server is transmitted to the vehicle and used as a control signal for bit rate generation within the vehicle. The target bit rate may be generated based on communication resources (which may be communication resources for each cell) of the radio access network (RAN) associated with the vehicle. In addition, the target bit rate may be generated by referring to the network bandwidth allowed for the RAN area associated with the vehicle. That is, if more traffic is generated in a first cell area than in a second cell area, a control signal for generating a lower target bit rate than in the second cell area can be generated in the first cell area. In addition, the target bit rate may be determined by determining whether the amount of data of the data specification information is higher or lower than a reference value in comparison with the network bandwidth allowed for the RAN area. If the amount of data is higher than the reference value, the target bit rate may be controlled to decrease, and if the amount of data is lower than the reference value, the target bit rate may be controlled to increase. Here, the reference value may be determined in proportion to the network bandwidth allowed for the RAN area associated with the vehicle. The reference value may be set to be higher as the allowed network bandwidth increases.

### Embodiment of Remote Driving

According to an embodiment of the present disclosure, the vehicle communication control system according to the present disclosure can be implemented for the purpose of remote driving.

Remote driving may refer to a method of allowing a remote driver or a driving system located in a service/control part to control an autonomous vehicle by remote driving instructions in a case where autonomous driving is not safe and/or a service that provides such a function. For the remote driving, an autonomous vehicle may be configured to transmit at least some of a large amount of data including camera images of the front and rear sides of the vehicle and other sensor data acquired for autonomous driving as data related to remote driving to the service/control part via a network (including a mobile communication network), and the service/control part may generate remote driving instructions with reference to the received data and allow the driver or driving system to drive the autonomous vehicle located in a remote location.

As described above, the remote driving instructions may be generated by various inputs from a human driver, such that a command through a computer, and input through a simulator that simulates conventional vehicle driving operations, may be generated by a separate autonomous driving function unit configured to be suitable for remote driving of the autonomous vehicle in the service/control part, or may be generated by a method that is not limited to such generation methods and provided.

In order for the remote driving to be performed safely, data related to the remote driving and information related to the remote driving instructions may need to be transmitted and received in real time through the service/control part. In addition, network stability may be required to ensure such transmission. In order to secure stability, the status of the network path connecting the autonomous vehicle and the service/control part may need to be continuously measured and evaluated, and information on the results may need to be collected. In addition, the service/control part may need a function of providing information on the status of the network path to at least one autonomous vehicle connected thereto, periodically, aperiodically, or temporarily.

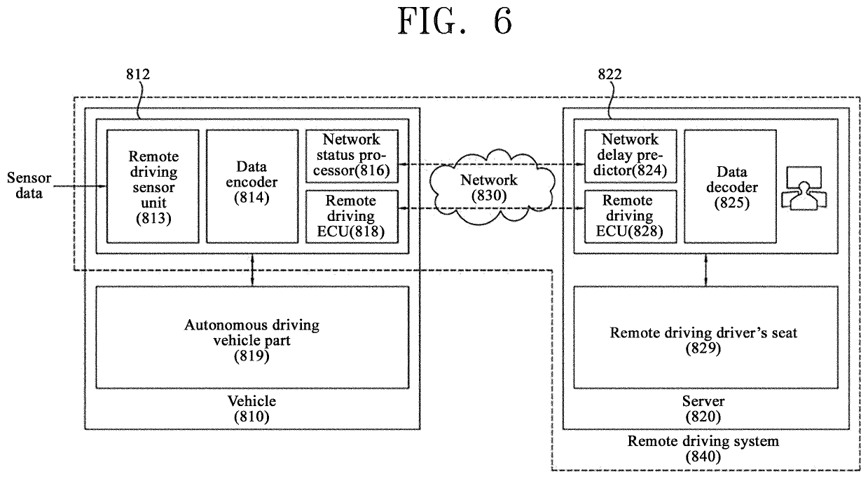

FIG. 6 is a block diagram showing the structure of a vehicle communication control system for remote driving according to an embodiment of the present disclosure. As shown in FIG. 6, the vehicle communication control system according to an embodiment of the present disclosure may include a vehicle 810 and a server system 820. The vehicle 810 and the server system 820 may be connected through a network 830.

The network 830 is a communication network through which data can be exchanged between the vehicle 810 and the server 820. According to an embodiment of the present disclosure, the network 830 may be implemented as various types of wireless networks such as 5G, 6G, 4G, LTE, 3G, and WiBro. Preferably, it may be implemented as a 5G network. Even if the network 830 is represented as a 5G network or an entity associated therewith (e.g., gNodeB), it will be obvious to those skilled in the art that the network 830 can be implemented as a 4G network, a 3G network or an entity associated therewith (eNodeB, NodeB).

Referring to FIG. 6, the vehicle 810 may include a remote driving unit 812 and an autonomous vehicle unit 819. The remote driving unit 812 is a functional unit serving to perform the remote driving function of the vehicle and may be composed of at least one partial functional unit and/or module. The remote driving unit 812 may be configured to simultaneously perform the functions of an autonomous driving unit, a data transmission unit, and a data control unit (such as modules 312, 314, and 316 shown in FIG. 3) in the autonomous vehicle, and may be implemented as a device or system including a common functional unit or at least one common functional unit that operates in the embodiment of the autonomous driving method described above in some cases and operates in an embodiment of a remote driving method which will be described below in other cases depending on specific conditions, environments, and situations.

The autonomous vehicle unit 819 may include mechanical, electronic, and/or other functional parts of the vehicle body that can be driven by receiving driving control in a manner including an electronic signal through the remote driving unit 812, or may be understood as a concept that collectively refers to such functional parts.

The remote driving unit 812 may include a remote driving sensor unit 813, a data encoder 814, a network status processor 816, and a remote driving ECU 818. The above functions and functional units may be configured as a single device, configured as independent devices, or configured as a mixture in which some thereof are combined and some thereof are configured as independent devices.

The remote driving sensor unit 813 may be configured to receive sensor data from a plurality of sensors arranged inside or around the vehicle. The sensors detect various types of information related to the surroundings of the vehicle, such as the front, rear, and side of the vehicle, and driving or safety of the vehicle.

The data encoder 814 may be configured to encode remote driving data including sensor data received by the remote driving sensor unit 813. The encoding may be a procedure of reprocessing at least one piece of remote driving data into an information sequence in a format suitable for communication by using at least one of concatenation, merging, listing, transformation, or encryption according to a predetermined information syntax. The encoding may be a reversible information processing method that is capable of decoding. The data encoder 814 may change the data encoding method based on a bit rate control signal provided from a network delay predictor 824, and by changing the encoding method, process data using at least one method among shortening, quantization, sampling, omission, lossless compression, and lossy compression to match the target bit rate.

The data encoder 814 may be configured to include a function of appropriately controlling the transmission bit rate of data related to remote driving of the vehicle, for example, data regarding the remote environment, by various methods including the above-described method, and then transmitting the data to the server system 820 via the network 830, or to include a functional unit and/or a module that performs such a function. In this case, the transmitting function may include a function for wired or wireless communication with respect to the network 830. Alternatively, the data encoder 814 may be configured to provide the transmission target data to the remote driving ECU 818 such that the remote driving ECU 818 transmits the data to the server system 820.

The network status processor 816 may be configured to communicate with the network delay predictor 824 of the server system 820, generate a packet for measuring the network status, and exchange the packet via the network 830. The packet may be referred to as a probe packet. In addition, the network status processor 816 may be configured to receive target bit rate information determined by the network delay predictor 824 and generate target bit rate information for controlling the bit rate of transmission target data related to remote driving of the vehicle, and may provide the target bit rate information to the data encoder 814 such that data encoding at a desired bit rate can be performed.

The remote driving ECU 818 on the vehicle side may be a functional unit configured to control the autonomous vehicle unit 819 in association with a remote driving ECU 828 of the server system 820. The control may include a function of directly providing information related to a remote driving instruction received from the remote driving ECU 828 on the server side to at least one vehicle function included in the autonomous vehicle unit 819. The control may include a function of generating a vehicle control instruction based on the received remote driving information and then controlling the autonomous vehicle unit 819 based on the vehicle control instruction. The control may include a function of intentionally omitting, supplementing, or correcting and relaying information related to driving control provided from the remote driving ECU 828 on the server side when the information is inappropriate or incomplete for achieving control of the autonomous vehicle unit 819.

The remote driving ECU 818 may include a function of transmitting information for the purpose of feedback regarding information related to driving control received from the remote driving ECU 828 on the server side to the remote driving ECU 828 on the server side. The remote driving ECU 818 may include a function of receiving data related to a remote environment associated with remote driving from at least one of the autonomous vehicle unit 819, the remote driving sensor unit 813, or the data encoder 814 and transmitting the same to the remote driving ECU 828 on the server side, or may be configured to include a functional unit and/or module that performs such a function. In this case, the transmitting function may include a function for wired or wireless communication with respect to the network 830.

Referring back to FIG. 6, the server system 820 may include a remote driving server 822 and a remote driving driver's seat 829. The remote driving server 822 is a functional unit serving to transmit a remote driving instruction to the vehicle 810, and may be composed of at least one partial functional unit and/or module. The remote driving server 822 may be configured to simultaneously perform the functions of the service/control part and the data control unit (such as the modules 322 and 324 shown in FIG. 3) in the autonomous driving server according to an embodiment of the present disclosure, and may be implemented as a device or system including a common functional unit or at least one common functional unit that operates in the aforementioned embodiment for providing the autonomous driving service in some cases and operates in an embodiment for providing a remote driving instruction which will be described below in other cases depending on specific conditions, environments, and situations.

The remote driving driver's seat 829 may be a functional unit configured to drive the autonomous vehicle located at a remote location by allowing a driver or the driving system to generate remote driving instructions with reference to data received through the remote driving server 822. In one embodiment, the remote driving driver's seat 829 may include various input means, for example, a human-computer interface (HMI) device including a keyboard, a mouse, a trackball, a touchscreen, etc. with respect to a computer.

In another embodiment, the remote driving driver's seat 829 may include a driving simulator device configured to include components of a vehicle driver's seat including a steering wheel, a gear box, and pedals to be able to simulate conventional vehicle driving operations, and a display displaying a virtual driving environment implemented by referencing the data. In another embodiment, the remote driving driver's seat 829 may be an automatic determination device that performs functions corresponding to the autonomous driving unit, and may include a separate functional unit for autonomous driving, which is configured to be suitable for generating remote driving instructions of the autonomous vehicle. The remote driving driver's seat 829 may be configured differently from the above embodiment, and remote driving instructions generated by the remote driving driver's seat 829 may be input to the remote driving server 822.

The remote driving server 822 may include a data decoder 825, the network delay predictor 824, and the remote driving ECU 828. Although not shown, the remote driving server 822 may further include the function of an Internet data collection server that collects data via the Internet. The above functions and functional units may be configured as a single device, configured as independent devices, or configured as a mixture in which some thereof are combined and some thereof are configured as independent devices.

The data decoder 825 may be configured to decode data received from the vehicle 810, for example, remote environment data when the data has been encoded. The decoding may be a procedure of reprocessing at least one piece of remote driving data received via the network 830 into data in a format that can be referred to by the remote driving driver's seat 829 for generating remote driving instructions by using at least one of partitioning, separation, selection, inverse transformation, and decryption methods. The decoding may refer to restoration of encoded information as a reversible information processing method. The data decoder 825 may change the data decoding method based on the bit rate control signal provided from the network delay predictor 824, and may restore data by using at least one of padding, inverse quantization, interpolation, extrapolation, and decompression methods by changing the decoding method.

The network delay processor 824 may include a device for monitoring the status of the network. For example, the network delay processor 824 may include a network monitoring device provided by a network operator. This may include a backhaul monitoring device, a core network monitoring device, etc. The network delay processor 824 may be configured to predict and analyze the current network status on the packet path based on a packet (for example, a probe packet) transmitted from the network status processor 816 on the side of the vehicle 810.

Then, based on the analysis results, the network delay processor 824 may generate information on communication-related parameters optimized for data communication with the vehicle 810 (for example, target bit rate information) and provide the same to the network status processor 816 via the network 830.

The remote driving ECU 828 on the server side may be a functional unit configured to generate control information for controlling the autonomous vehicle unit 819 at a remote location in association with the remote driving ECU 818 on the side of the vehicle 810. The control information may include information generated for the purpose of transmitting information related to a remote driving instruction received from the remote driving driver's seat 829 to the vehicle 810, the remote driving unit 812 of the vehicle, and/or the vehicle-side remote driving ECU 818 of the remote driving unit. The control may include a function of generating a vehicle control instruction based on the received remote driving information and then generating information to be transmitted to the ECU based on the vehicle control instruction. If information related to the remote driving instruction provided from the remote driving driver's seat 829 is inappropriate or incomplete for achieving control of the vehicle 810, a function of intentionally omitting, supplementing, or correcting the information may be included in the process of generating the information.

In the process of generating the information, the remote driving ECU 828 may refer to control information. The control information may be environmental information for controlling remote driving, and according to an embodiment, may include information such as information on the weather at the location of the vehicle 810 and a minimum required delay time required for remote driving of the vehicle 810. According to an embodiment, the control information may also be supplied to the network delay processor 824.

The remote driving ECU 828 may include a function of directly transmitting information related to driving control to the remote driving ECU 818 on the vehicle side, or may be configured to include a functional unit and/or module that performs such a function. In this case, the transmitting function may include a function for wired or wireless communication for the network 830. In addition, the transmitting function may include a function of encoding information similar to the operation of the data encoder 814 described above, according to an embodiment, and in this case, the remote driving ECU 818 on the vehicle side may be configured to include a function of decoding information similar to the operation of the data decoder 825 described above.

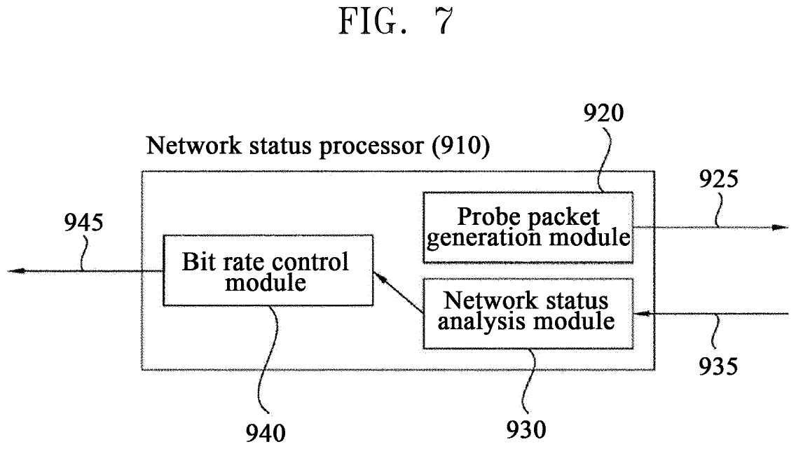

FIG. 7 is a block diagram showing a structure of a network status processor according to an embodiment of the present disclosure. Referring to FIG. 7, the network status processor 910 according to an embodiment of the present disclosure may include a probe packet generation module 920, a network status analysis module 930, and a bit rate control module 940.

The probe packet generation module 920 may be configured to generate a probe packet for measuring a network delay time and transmit (925) the probe packet to a network delay measuring unit of the remote driving server.

The network status analysis module 930 may be configured to receive (935) a packet delay estimation time transmitted by the network delay measuring unit of the remote driving server, analyze the current network status, and transmit the analysis result to the bit rate control module 940.

The bit rate control module 940 may receive the current network status transmitted by the network status analysis module 930 and send a request corresponding to one of increasing, maintaining, and decreasing a communication bit rate to the remote driving ECU and/or the data encoder.

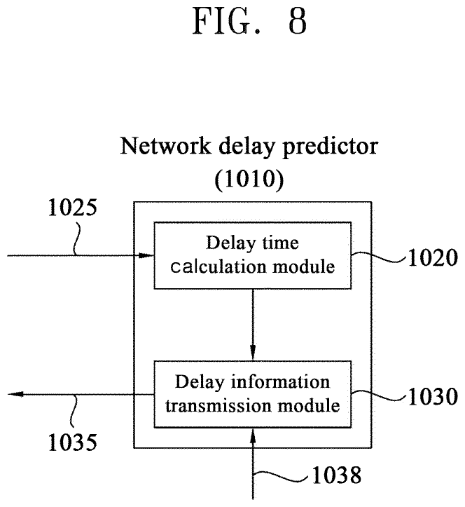

FIG. 8 is a block diagram showing a structure of a network delay predictor according to an embodiment of the present disclosure.

Referring to FIG. 8, the network delay predictor 1010 according to an embodiment of the present disclosure may include a delay time calculation module 1020 and a delay information transmission module 1030.

The delay time calculation module 1020 may be configured to receive (1025) a probe packet transmitted by the probe packet generation module that may be included in the network status processor, calculate a delay time occurring in the network based on the received probe packet, and provide information related to the calculated delay time to the delay time transmission module 1030.

The delay time transmission module 1030 may be configured to determine the content of final delay information by using the information related to the provided delay time and control information related to remote driving shared by the remote driving ECU on the server side, and transmit the delay information to the network status analysis module that may be included in the network status processor. The control information may be information for controlling the environment in which remote driving is performed, and according to an embodiment, may include information on the weather at the location of the vehicle that is the target of remote driving, and a minimum required delay time required for remote driving.

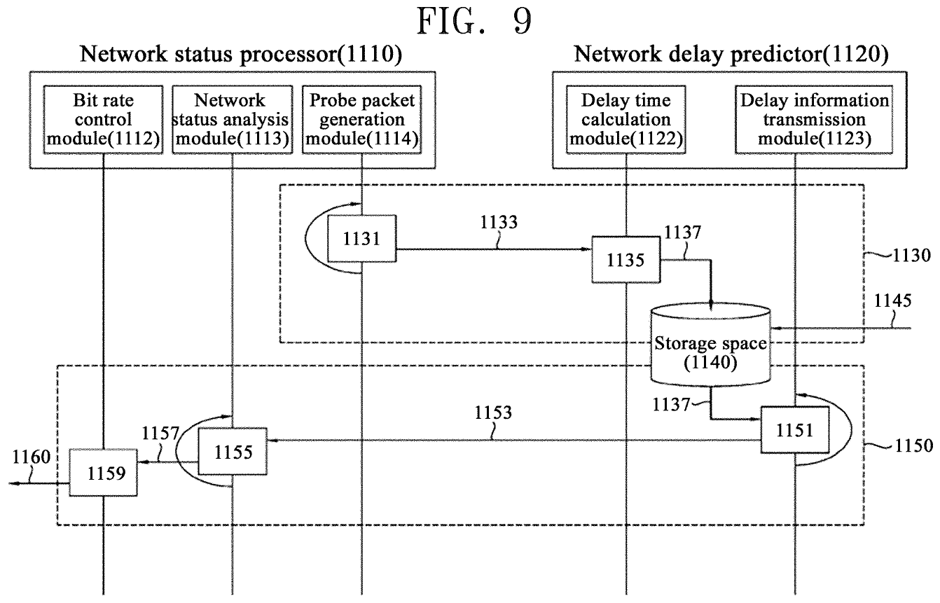

FIG. 9 is a flowchart showing a vehicle communication control method for remote driving according to an embodiment of the present disclosure.

Referring to FIG. 9, a network status processor 1110 may correspond to the network status processor 910 illustrated in FIG. 7, and a network delay predictor 1120 may correspond to the network delay predictor 1010 illustrated in FIG. 8.

The linkage between the network status processor 1110 and the network delay predictor 1120 may be configured to include a network status analysis step 1130 and a bit rate control request step 1150.

The network status analysis step 1130 may be performed in the following order according to a preferred embodiment of the present disclosure, but is not necessarily limited to this order.

First, in order to analyze the status of a network path (e.g., the network 830 illustrated in FIG. 6) formed between a server system including at least a remote driving server (which may be the server system 820 illustrated in FIG. 6) and a tele-operated vehicle connected to the server system (e.g., which may be the vehicle 810 illustrated in FIG. 6), a probe packet generation module 1114 (which may be the module 920 illustrated in FIG. 7) may generate (1131) a probe packet at a regular interval and transmit the same to the server system, according to a preferred embodiment of the present disclosure.

Upon reception of the probe packet, a network delay time calculation module 1122 (which may be the module 1020 illustrated in FIG. 8) of the network delay predictor 1120 may calculate a delay time for packet communication. According to an embodiment, the delay time may be a delay time for uplink communication. The network delay time calculation module 1122 may store (1137) information related to the calculated delay time in a storage space 1140.

According to an embodiment of the present disclosure, the storage space 1140 may further store control information 1145 related to remote driving. The control information 1145 may be information for controlling the environment in which the remote driving is performed, and according to an embodiment, may include information on the weather at the location of the vehicle 810 and information such as the minimum required delay time required for remote driving of the vehicle 810.

The bit rate control request step 1150 may be performed in the following order according to a preferred embodiment of the present disclosure, but is not necessarily limited to this order.

First, a delay information transmission module 1123 may be configured to periodically generate (1151) delay information based on information related to the delay time stored (1137) in the storage space 1140, or information including the control information 1145 according to an embodiment, and transmit (1153) the delay information to a network status analysis module 1113. Based on the transmitted (1153) delay information, the network status analysis module 1113 may periodically generate (1155) information related to the network status and transmit (1157) the information to a bit rate control module 1112 according to a preferred embodiment of the present disclosure. The bit rate control module 1112 may be configured to generate (1159) information related to a specific bit rate control method based on the information, and transmit (1160) the information to the remote driving ECU.

Hereinafter, a detailed embodiment related to the details of the linkage process based on FIG. 9 will be described. The following embodiment may include a specific or schematic implementation result of the linkage process in FIG. 9, but the linkage process according to the present disclosure, the vehicle control method by such linkage process, and the device and/or system related to such method are not necessarily limited to the following embodiment.

First, in an embodiment of the present disclosure related to the network status analysis step 1130, the operation of the probe packet generation module 1114 may include or be based on an operation represented by the following pseudocode.

TABLE 1

SetTimer(Probe_Timer=1000 ms)
LOOP:
TimerWait( );
Send(Probe_Packet);
END LOOP

The generation (1131) and transmission (1133) of the probe packet may be performed at regular intervals, irregular intervals, or temporarily, but the pseudocode representing a preferred embodiment of the present disclosure assumes a case in which the probe packet is generated and transmitted at regular intervals. Therefore, the embodiment of the pseudocode shows an example of generating (1131) a probe packet based on a timer with a 1-second interval and transmitting (1133) the probe packet.

The probe packet transmitted (1133) described above may be a universal protocol-based communication packet including the following packet information.

1) VEH_ID, 2) MSG_ID, 3) ENC_TY, and 4) RES.

The meaning of each of the packet information above may be, for example, as shown in the table below.

TABLE 2

| Item | Field name | Value example | Description | Size (bit) |
|---|---|---|---|---|
| Vehicle ID | VEH_ID | 0x33 | Vehicle ID (0 to 255) | 8 |
| Message ID | MSG_ID | 0x01 | Message ID (0 to 255) | 8 |
| Encoding type | ENC_TY | 0x01 | Message encoding type | 8 |
| | | | (0: None, 1: JSON | |
| Reserved | RES | NULL | Additional field | 8 |
| | | | (reserved area) | |

In an embodiment of the present disclosure, the operation of the delay time calculation module 1122 may include or be based on an operation represented by the following pseudocode.

TABLE 3

```
EVENT: Calculate Delay Time (Probe_Packet)
  Receive_Packet = GetPacket( );
  Reordered_Packet = PacketReordering (Receive_Packet)
  Now = GetTime (Reordered_Packet);
  Delay Time = Now - Pre;
  Save (Delay Time);
  Pre = Now;
END EVENT
```

The delay time calculation module 1122 may operate (1135) whenever a probe packet is received (1133). However, the transmission order and the reception order of probe packets received via a network path may not match and may be swapped. Therefore, for such a case, at least one of the received probe packets may be realigned to match the correct order. In an embodiment of the present disclosure, the delay time calculation module 1122 may operate (1135) to calculate the delay time on the network path connected between the network status processor 1110 and the network delay predictor 1120, i.e., between the vehicle and the server system, by measuring the reception interval of the realigned probe packets. In addition, the delay time calculation module 1122 may be configured to store (1137) information related to the calculated delay time in the storage space 1140, which may be regarded as a part of the server system according to an embodiment.

According to an embodiment of the present disclosure, the storage space 1140 may further store the control information 1145 related to remote driving. The control information 1145 may be information for controlling the environment in which the remote driving is performed, and according to an embodiment, may include information on the weather at the location of the vehicle 810 and a minimum required delay time required for remote driving of the vehicle 810.

Next, in an embodiment of the present disclosure related to the bit rate control request step 1150, the operation of the delay information transmission module 1123 may include or be based on an operation represented by the following pseudocode.

TABLE 4

```
SetTimer (Res_Timer=500 ms);
LOOP:
  Timer Wait( );
  Load(Delay_Time, Cont_Info);
  Delay_Info = Make_Info(Delay_Time, Cont_Info);
  Send (Delay_Info);
END LOOP
```

The delay information transmission module 1123 may be configured to obtain (1147) information related to the delay time and the control information from the storage space 1140 and generate (1151) network delay information. The generation (1151) and transmission (1153) of the network delay information may be performed at regular intervals, at irregular intervals, or temporarily, but the pseudocode representing a preferred embodiment of the present disclosure assumes a case in which the network delay information is generated and transmitted at regular intervals. Therefore, the embodiment of the pseudocode shows an example of generating (1151) and transmitting (1153) the delay information based on a timer with a 500-millisecond interval.

The information transmitted (1153) may include information related to the calculated delay time, and in addition, may include a case where the probe packet is not transmitted (1133) or the control information stored in the storage space 1140 includes important control information transmitted from the control system, and may be a universal protocol-based communication packet including the following packet information.

1) VEH_ID, 2) MSG_ID, 3) ENC_TY, and 4) RES.

The meaning of each of the above packet information may be, for example, as shown in the table below.

TABLE 5

| Item | Field name | Value example | Description | Size (bit) |
|---|---|---|---|---|
| Vehicle ID | VEH ID | 0x01 | Vehicle ID (0 to 255) | 8 |
| Message ID | MSG_ID | 0x11 | Message ID (0 to 255) | 8 |
| Encoding type | ENC_TY | 0x01 | Message encoding type (0: | 8 |
| | | | None, 1: JSON) | |
| Delay | DLY_IF | 0x3F | Delay information | 8 |
| information | | | 8 to 7 bits: network status | |
| | | | (00: 630 ms or less, | |
| | | | 01: 630 ms or more, | |
| | | | 10: RESERVE, | |
| | | | 11: Disconnection | |
| | | | recommended) | |
| | | | 1 to 6 bits: Uplink delay time | |
| | | | (value * 10 ms: 10 ms to 630 | |
| | | | ms) | |

In an embodiment of the present disclosure, the operation of the network status analysis module 1113 may include or be based on an operation represented by the following pseudocode.

TABLE 6

```
EVENT: Make Network Stat (Delay_Info)
  Net Delay, Net_Info = GetPacket( );
  Updated = Yes;
END EVENT
SetTimer (Stat_Timer=500 ms);LOOP:
  TimerWait( );
  Timer Count++;
  IF (Updated || Timer_Count)
    Req = Make_Requirement (Net_Delay, Net_Info);
    Updated=No;
    Timer_Count=0;
  ELSE
    Continue;
END LOOP
```

The delay information transmitted (1153) from the delay information transmission module 1123 (i.e., a functional unit of the network delay predictor 1120 that may be included in the remote driving server on the server system side, according to an embodiment) may be configured to be input to the network status analysis module 1113 (i.e., a functional unit of the network status processor 1110 that may be included in the remote driving unit on the vehicle side, according to an embodiment). The network status analysis module 1123 may operate dependently on or irrespective of the reception (1153) of the delay information, and the operation may be performed at regular intervals, irregular intervals, or temporarily. However, the pseudocode representing a preferred embodiment of the present disclosure assumes a case in which the operation is performed at regular intervals irrespective of the reception (1153) of the delay information. Therefore, the embodiment of the pseudocode shows an example of operating periodically (1155) based on a timer with an interval of 500 milliseconds.

The network status analysis module 1113 may be configured to generate information related to the network status using information including the currently received (1153) delay information and an elapsed time for which the delay information is not received, according to the operation (1155) and transmit (1157) the same to the bit rate control module 1112.

The contents of the message Req transmitted (1157) may be, for example, as shown in the table below.

TABLE 7

| | Variable | Value | | Size |
|---|---|---|---|---|
| Item | name | example | Description | (bit) |
| Request | Req | 5 | Bit rate control amount | 8 |
| information | | | (1 to 5) | |
| | | | (1: Large bit rate | |
| | | | reduction | |
| | | | 2: Small bit rate | |
| | | | reduction | |
| | | | 3: Bit rate maintained | |
| | | | 4: Small bit rate | |
| | | | increase | |
| | | | 5: Large bit rate | |
| | | | increase) | |

In an embodiment of the present disclosure, the operation of the bitrate control module 1112 may include or be based on an operation represented by the following pseudocode.

TABLE 8

```
EVENT: Request (Req)
  IF (Req < 3)
    Reduce( );
  ELSE IF (Req >3)
    Increase( );
  ELSE
END EVENT
```

The bit rate control module 1112 may operate (1159) whenever an information message regarding the network status is received (1157). As in the embodiment shown in the pseudocode, the bit rate control module 1112 may be configured to generate a request for a specific bit rate control method corresponding to one of increasing, maintaining, and decreasing a communication bit rate and transmit (1160) the same to the remote driving unit installed in the vehicle (which may be a functional unit including the data encoder and/or the remote driving ECU belonging to the remote driving unit according to an embodiment).

### Method of Setting Operating State of Tele-Operated Vehicle and Device Therefor

Hereinafter, a method of setting an operating state of a tele-operated vehicle which can be performed in combination with the embodiments described above and a device therefor will be described.

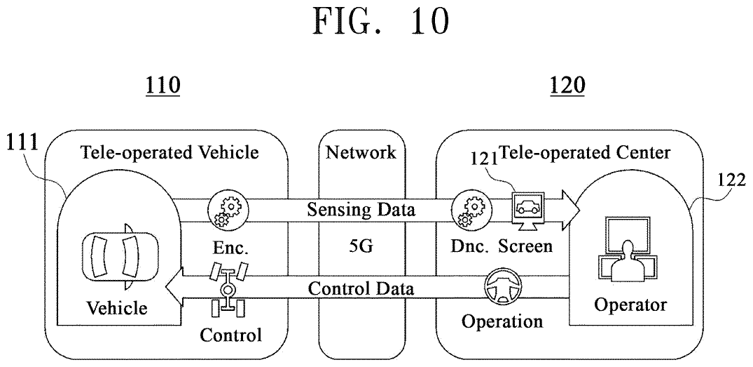

FIG. 10 is a diagram illustrating components of a tele-operated driving (ToD) system.

Referring to FIG. 10, the ToD system may be configured such that a tele-operated vehicle (ToV) 110 and a tele-operated center (ToC) 120 transmit and receive ToD-related signals through a network.

The ToV 110 may encode information such as sensing data from a vehicle 111 and transmit the same to the ToC 120 through a network (5G or other networks such as LTE as illustrated). The ToC 120 may provide information to a remote driving operator 122 in a manner of decoding the data received from the ToV 110 and reproducing the same on a screen 121. In addition, the ToC 120 may secure additional data such as images of a camera installed in the infrastructure in addition to the data received from the ToV 110 and provide the same to the operator 122.

When the operator 122 performs an operation required for remote driving (e.g., operating a remote driving device or driving device for driving) based on the above information, information related thereto may be transmitted to the ToV 110 through the network. At this time, the operator 122 may be a remote driver of the ToC 120, but human intervention is not necessarily required, and the operator 122 may be implemented as an artificial intelligence robot that supports remote driving through artificial intelligence.

If the operator 122 of the ToC 120 is implemented as an artificial intelligence robot for remote driving, the operator 122 can safely provide a remote driving service by utilizing information (e.g., infrastructure information, etc.) superior to information provided by the ToV 110 or the artificial intelligence robot of the (autonomous) vehicle within the ToV 110.

As described above, the ToV 110, which has received the driving control signal from ToC 120, may transmit the received information to the vehicle 111 or the ECU (not shown) of the vehicle to enable driving corresponding to the operation.

In the embodiment illustrated in FIG. 10, the configuration of ToV 110 may be configured in combination with the configuration of the vehicle 810 of FIG. 6, and the configuration of ToC 120 may be configured in combination with the remote driving system 840 of FIG. 6.

Based on the configuration of the ToD system as described above, operating states of a ToV will be described. As described above, in one aspect of the present disclosure, the operating states of a ToV are defined in order to provide a standardized ToD service regardless of ToD service providers.

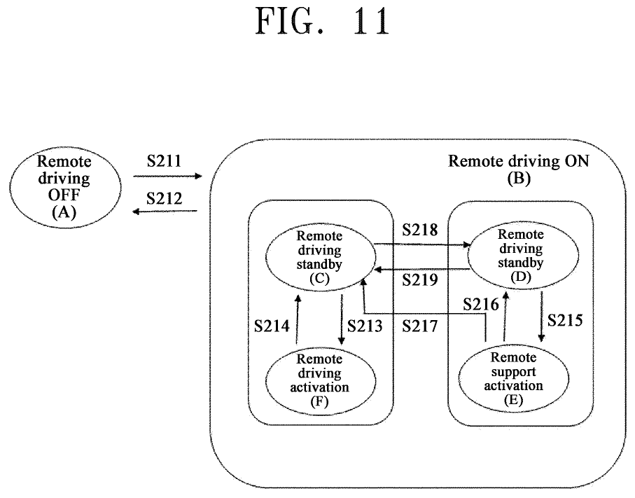

FIG. 11 is a diagram illustrating operating states of a ToV for providing a standardized ToD service.

As shown in FIG. 11, the operating states of the ToV may be broadly divided into a remote driving OFF state A and a remote driving ON state B. In an embodiment of the present disclosure, it is assumed that the ToV can switch to the remote driving ON state B only when the autonomous driving function is activated. Therefore, if the ToV receives a remote driving ON instruction from the ToC or an administrator and satisfies self-verification results including whether the autonomous driving function of the ToV is activated, the operating state can be switched to the remote driving ON state B (S211). On the other hand, if the ToV receives a remote driving OFF instruction from the ToC or administrator, the ToV can switch to the remote driving OFF state (S212).

In the example shown in FIG. 11, the remote driving ON state (B) may be broadly divided into states C and F for providing the remote driving service and states D and E for providing a remote support service.

The states D and E for providing the remote support service refer to states in which ToV state monitoring information including ToV surrounding images, etc. are received from the ToV, and the remote driver of the ToC can provide auxiliary information for ToV operation based on the ToV state monitoring information. The states D and E for providing the remote support service differ from the states C and F for providing the remote driving service which will be described below in that a dynamic driving task (DDT) and/or DDT fallback for the ToV are not performed.

The states C and F for providing the remote driving service refer to states in which the remote driver of the ToC performs direct driving control (e.g., DDT and/or DDT fallback control) for the ToV based on the monitoring information described above. That is, in the description below, remote driving refers to DDT and/or DDT fallback provided by the remote driver, and the DDT fallback may include, for example, braking, acceleration, steering, and gear shifting in an emergency situation.

As illustrated in FIG. 11, both the states C and F for providing the remote driving service and the states D and E for providing the remote support service may include standby states C and D.

For example, in order to switch the ToV to the remote driving activation state F, transition from the remote driving standby state C to the remote driving activation state F may occur if there is a response from the remote driver of the ToC (S213). On the other hand, if the remote driver of the ToC cannot perform the operation during operation in the remote driving activation state F, the ToV may switch to the remote driving standby state C (S214).

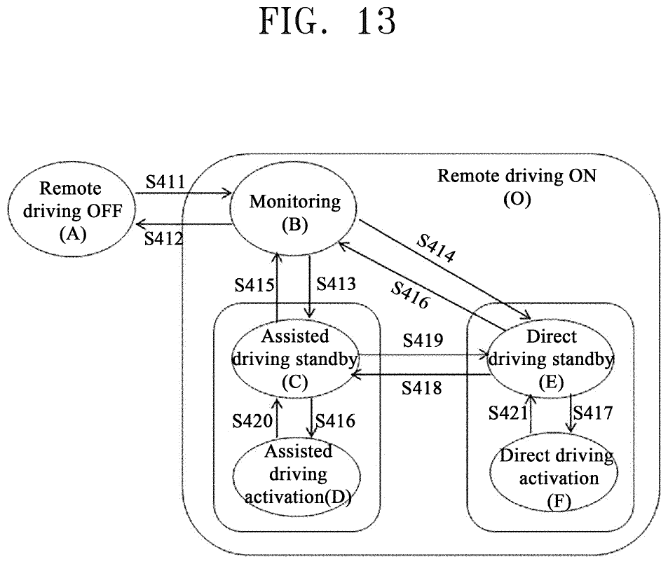

Similarly, for transition to the remote support activation state E, transition from the remote support standby state D to the remote support activation state E may occur if there is a response from the remote driver of the ToC (S215). In addition, when the service is terminated in the remote support activation state E and the ToC terminates the remote support activation state E, the ToV can switch to the remote support standby state D (S216). The ToC may also instruct direct transition to the remote driving standby state C instead of the remote support standby state D as shown in FIG. 13 (S217).

Transition between the remote driving standby state C and the remote support standby state D may occur depending on the situation in which the ToV requires remote driving (S218 and S219).

As shown in FIG. 11, if the operating states of the ToV are specifically defined and operated in a standardized manner regardless of the manufacturer, the problem of restrictions due to different regulations of ToD service providers can be solved.

However, in a case where the operating states of the ToV are defined as in the embodiment described above with respect to FIG. 11, if the remote driver of the ToC fails to respond to a request for entering the remote support activation state E and/or a request for entering the remote driving activation state F from the ToV, there is a problem that the ToV must remain in the standby states C and D.

That is, according to the method shown in FIG. 11, when the ToV is in a situation where autonomous travel is not possible, the ToC driver takes over the driving at the request of the ToV, and when the ToC wants to end remote driving, the ToV receives the request from the ToC, stops remote driving, prepares to switch to autonomous driving, and then ends remote driving. In other words, the embodiment of FIG. 11 can be regarded as an embodiment that can be supported only when there is a remote driver in the ToC.

However, in this method, from the perspective of the ToV, even if there is a remote control request from the ToV (e.g., a request from a driver or autonomous driving machine), when there is no response from the remote driver in the ToC, the ToV cannot receive the remote driving service. In addition, from the perspective of the ToC, the ToC cannot be flexibly remotely controlled depending on the situation of the remote center. For example, there is a limitation that the ToC driving must be terminated whenever the remote driver in the ToC cannot concentrate on driving (e.g., going to the bathroom, falling asleep, etc.).

From the perspective of the ToV, if the ToV driver cannot drive or the autonomous driving machine of the ToV cannot drive autonomously, the ToV must wait for connection to the ToC. Sometimes, this can be dangerous when the ToV is in an emergency situation.

In addition, when there are multiple ToVs transmitting requests for remote driving to the ToC, it is impossible to provide a service for selecting a ToV with a high priority and performing remote driving on this ToV first. Since a ToV that has been connected must complete safe remote driving first and then be disconnected, it is difficult to change the remote driving priority and provide the service even if a ToV in a more urgent state than the preceding ToV occurs.

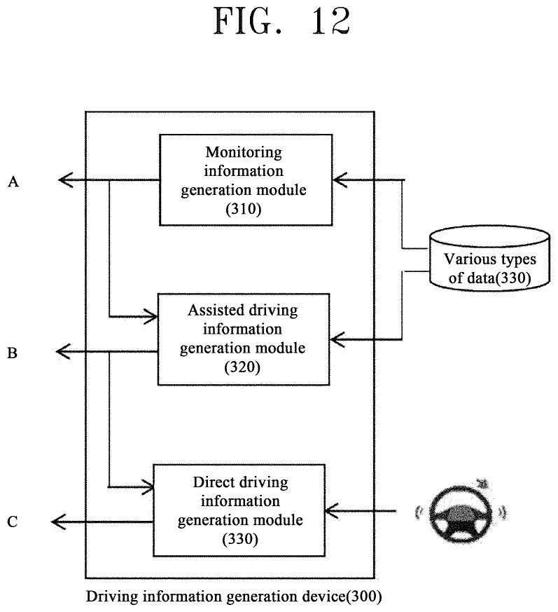

FIG. 12 is a diagram illustrating a configuration of a ToD system according to an embodiment of the present disclosure.

First, in order to solve the problem of defining the operating states of the ToV in the remote driving ON state as two states, such as (1) a state for providing the remote driving service (C and F) and (2) a state for providing the remote support service (D and E), as shown in FIG. 11, the present embodiment proposes a method of dividing the operating states of the ToV into three states, such as (1) a monitoring state, (2) an assisted driving state, and (3) a direct driving state in the remote driving ON state and operating the ToV.

FIG. 12 illustrates the configuration of a driving information generation device 300 for supporting these three operating states of the ToV.

As shown in FIG. 12, the driving information generation device 300 may include a monitoring information generation module 310, an assisted driving information generation module 320, and a direct driving information generation module 330.

As shown in FIG. 12, the monitoring information generation module 310 and the assisted driving information generation module 320 may refer to various types of data 330 used by the ToV or related to the operation of the ToV. The data 330 may include, for example, routes, weather, maps, surrounding conditions, infrastructure sensing, vehicle location, network status, vehicle sensor information, etc.

The monitoring information generation module 310 may generate monitoring information A from the data 330. The monitoring information A may be information simply monitored by a ToV/ToV driver without directly intervening in remote driving, such as vehicle location data, route data, weather information, presence or absence of surrounding accidents, and the network status.

The remote driver or autonomous machine that performs monitoring can simply monitor without doing anything. At this time, the ToC does not transmit any information about ToV control and can communicate with passengers/or the drivers in the ToV through the connected network.

At the same time, the assisted driving information generation module 320 may generate assisted driving information B using the information and the monitoring information generated by the monitoring information generation module 310. The assisted driving information B may include information on driving guides for reaching a destination, such as the lane in which the vehicle needs to be currently located, retransmission of an avoidance route, and a target speed of the vehicle, rather than direct driving information such as the DDT and/or DDT fallback described above.

The direct driving information generation module 330 may output a direct driving control signal from the ToC with reference to this assisted driving information. Direct driving information is generated by a remote driver riding in the driver's seat installed in the ToC and directly controlling the driving device by referring to images of the outside of the vehicle transmitted by the ToV, and specifically, it may mean all direct signals that control the vehicle, such as a brake force, accelerator torque, transmission information (front and rear directions), and turn signal information.

FIG. 13 is a diagram specifically illustrating the method of operating ToC operation states according to an embodiment of the present disclosure.

In the embodiment illustrated in FIG. 13, the operating state of the ToV may be set to either a remote driving OFF state A or a remote driving ON state O based on information on the ToV, similarly to the embodiment of FIG. 11. When an instruction for transition to the remote driving ON state O for the ToV is received from the ToC or the instruction is received by another manager, the ToV can switch to the remote driving ON state depending on whether the criteria for the autonomous driving function and the communication state are satisfied (S411). In addition, the operating state of the ToV may be switched back to the remote driving OFF state by the ToC or the manager (S412).

As described above, in the present embodiment, the operating state of the ToV in the remote driving ON state O may be divided into three states: (1) monitoring state B, (2) assisted driving states C and D, and (3) direct driving states E and F.

The monitoring state B may refer to a state in which there is no driving involvement for the ToV and monitoring information on the surroundings of the ToV is collected. The assisted driving state C and D may refer to a state in which driving assistance information is provided for the ToV based on the monitoring information and is characterized by being a state in which driving assistance information is provided for the ToV without involvement of the remote driver of the ToC, in contrast to the remote support state (D and E in FIG. 13) in the embodiment of FIG. 13.

The remote driving state E and F is a state in which the remote driver of the ToC provides a driving control signal for the ToV, and in this state, the ToV can receive the DDT and/or DDT fallback control described above from the ToC.

In a preferred embodiment of the present disclosure, when the ToV enters the remote driving ON state O, the ToV automatically enters the monitoring state B (S411). In this state, the current driving situation of the ToV and environmental information can be simply monitored, and at this time, a person monitoring the remote location or a machine monitoring the remote location does not transmit any control information to the ToV, and simply performs monitoring.

At this time, if a situation where the ToC needs to be controlled arises due to a specific situation, the ToV may enter the assisted driving state C and D from the monitoring state B (S413) or may enter the direct driving state E and F in which direct driving is required (S414). Determination of state transition due to such a specific situation may be performed in the ToC based on a request signal of the ToV and monitoring information with respect to the ToV.

As described above, when the ToV enters the assisted driving state C and D or the direct driving state E and F (S413 or S414), it is desirable to maintain the standby mode state C and E of each state preferentially. In this standby mode state C and E, if the ToV is in a state where autonomous driving is possible again or remote control is not required, the operating state may return to the monitoring state B again (S415 or S416).

In addition, when preparations for each state D or F are complete (checking that various types of information are received correctly, the network status is good, and there are no errors), it is possible to enter the active state D or F of each state.

In the following description, a request signal requesting transition to the assisted driving state C and D from the ToV is referred to as a first request signal, and a request signal requesting transition to the remote driving state E and F is referred to as a second request signal.

In addition, in a preferred embodiment of the present disclosure, if the ToC does not send a response to the second request signal within a predetermined period after receiving the second request signal from the ToV, the ToV switches to the assisted driving state C and D even though the ToV has requested transition to the remote driving state.

In the embodiment of FIG. 13, in order to enter the direct driving activation state F from the direct driving standby state F (S417), it is required to receive a response from the remote driver of the ToC. However, as described above, if the remote driver of the ToC cannot respond, the ToV must remain in the direct driving standby state E, and a problem may occur if the ToV is in an emergency situation.

Therefore, in the present embodiment, the ToV can switch to the assisted driving state C and receive driving assistance without involvement of the remote driver of the ToC when the remote driver of the ToC cannot respond to the second request signal of the ToV within a predetermined period of time. As described above, in the assisted driving activation state D, driving assistance information can be provided without involvement of the remote driver, and therefore, transition (S416) from the assisted driving standby state C to the assisted driving activation state D does not require a response from the remote driver.

In summary, common requirements for transition from the standby state C or E of each state to the activation state D or F (S416 and S417) may include whether monitoring information is secured, the degree of communication delay between the ToV and the ToC, and presence or absence of an error. In addition, a response from the remote driver is required for transition from the direct driving standby state E to the direct driving activation state F (S417).

The ToC may change the operating states of the ToV to each other as needed (S418 and S419). In addition, when the ToD service provision situation in the activation states D and F is terminated, transition of the activation states D and F to the standby states C and E occurs (S420 and S421).

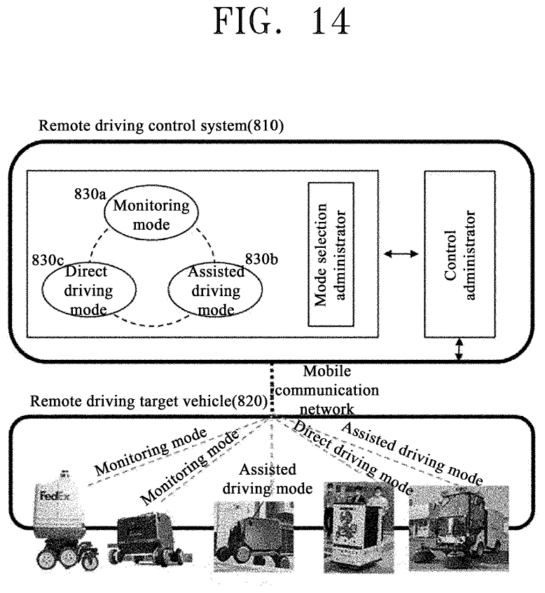

FIG. 14 is a diagram showing a configuration of a remote driving system according to an embodiment of the present disclosure.

As shown in FIG. 14, remote driving according to the present embodiment may mean a service in which a remote driving control system 810 drives one or more remote driving target vehicles 820, such as a delivery robot 820a and an autonomous shuttle 820b, using a mobile communication network.

The remote driving control system 810 may perform one of a monitoring mode 830a, an assisted driving mode 830b, and a direct driving mode 830c in order to control the remote driving target vehicles 820. These modes may correspond to the monitoring state, the assisted driving state, and the direct driving state in the above-described embodiments, and “state” and “mode” may be used interchangeably unless there is a special distinction.

Specifically, the control system 810 performing the monitoring mode 830a may monitor the following using information transmitted from the remote driving target vehicle 820.
The communication status of the mobile communication network between the remote driving target vehicle 820 and the control system 810
The surrounding environment of the remote driving target vehicle 820
The status of the remote driving target vehicle 820
The status of passengers/objects in the remote driving target vehicle 820

The control system 810 in the assisted driving mode 830b assists the remote driving target vehicle 820 and may transmit the following information for vehicle driving.
Driving route information
Target speed information
Stop command information

The control system 810 in the direct driving mode 830c directly drives the remote driving target vehicle 820 and transmits the following signals for vehicle driving.
Power control signals (braking, acceleration, steering, forward/backward, and shifting)
Directional signal (left, right, and reverse)
Lighting device signals (headlights, high beams, and tail lights)

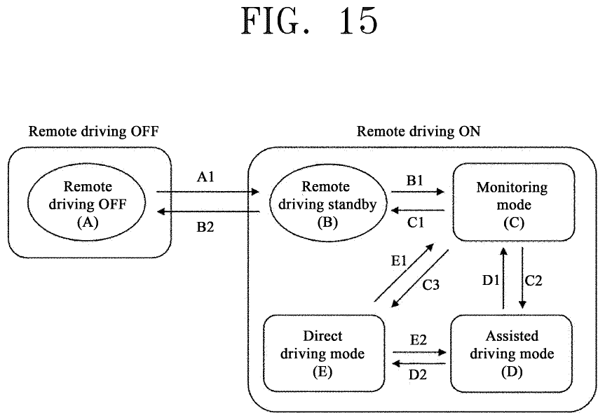

FIG. 15 is a diagram showing mode switching states in a remote driving system according to another embodiment of the present disclosure.

Specifically, the embodiment shown in FIG. 15 shows five states of the remote driving control system. As shown in FIG. 15, the three driving modes of the control system have their own states, and additionally include two states: a remote driving OFF state and a remote driving standby state.

The remote driving control system may have a total of five states: a remote driving OFF state, a remote driving standby state, a monitoring mode state, a direct driving mode state, and an indirect driving mode state.

### Remote Driving OFF State A

In the embodiment of FIG. 15, state A is a state in which a remote driving target vehicle is not connected to the remote driving control system. The remote driving control system may wait for a connection attempt from a remote driving target vehicle.

### Remote Driving Standby State B

In the embodiment of FIG. 15, state B is a state in which a remote driving target vehicle is connected to the control system, and the control system may initialize the system to prepare for remote driving and self-verify functions required for each remote driving mode.

### Monitoring Mode State C

In the embodiment of FIG. 15, state C may be a state in which a remote driving target vehicle is connected to the control system, and the control system performs remote driving in the monitoring mode.

### Assisted Driving Mode State D

In the embodiment of FIG. 15, state D may be a state in which a remote driving target vehicle is connected to the control system, and the control system performs remote driving in the assisted driving mode.

### Direct Driving Mode State E

In the embodiment of FIG. 15, state E may be a state in which a remote driving target vehicle is connected to the control system, and the control system performs remote driving in the direct driving mode.

Hereinafter, conditions for transition between the states described in the embodiment of FIG. 15 will be described in detail.

### State Transition A1

This indicates a case of transition of the control system from state A to state B. A trigger condition for this transition is that the control system receives a connection request from a remote driving target vehicle.

### State Transition B1

This indicates a case of transition of the control system from state B to state C. A trigger condition for this transition is that the control system, which has received a connection request from a remote driving target vehicle, completes self-verification in state B.

### State Transition B2

This indicates a case of transition of the control system from state B to state A. Trigger conditions for this transition may be:
a case where the control system receives a remote driving OFF request from a remote driving target vehicle and responds that remote driving OFF is possible; and
a case where the control system sends a request for remote driving OFF to the remote driving target vehicle and receives a ready signal from the vehicle.

### State Transition C1

This indicates a case of transition of the control system from state C to state B. A trigger condition for this transition is that the control system operating in the monitoring mode receives a remote driving OFF request from a remote driving target vehicle and terminates the monitoring mode.

### State Transition C2

This indicates a case of transition of the control system from state C to state D. A trigger condition for this transition is that the control system operating in the monitoring mode receives a request for transition to the assisted driving mode from a remote driving target vehicle and the transition is possible.

### State Transition C3

This indicates a case of transition of the control system from state C to state E. A trigger condition for this transition is that the control system operating in the monitoring mode receives a request for transition to the direct driving mode from a remote driving target vehicle and the transition is possible.

### State Transition D1

This indicates a case of transition of the control system from state D to state C. Trigger conditions for this transition may be:
a case where the control system operating in the assisted driving mode receives a request for transition to the monitoring mode from a remote driving target vehicle and the transition is possible; and
a case where the control system operating in the assisted driving mode receives a request for remote driving OFF from a remote driving target vehicle.

### State Transition D2

This indicates a case of transition of the control system from state D to state E. A trigger condition for this transition is that the control system operating in the assisted driving mode receives a request for transition to direct driving from a remote driving target vehicle and the transition is possible.

### State Transition E1

This indicates a case of transition of the control system from state E to state C. Trigger conditions for this transition may be:
a case where the control system operating in the direct driving mode receives a request for transition to the monitoring mode from a remote driving target vehicle and the transition is possible; and
a case where the control system operating in the direct driving mode receives a request for transition to remote driving OFF from a remote driving target vehicle.

### State Transition E2

This indicates a case of transition of the control system from state E to state D. A trigger condition for this transition is that the control system operating in the direct driving mode receives a request for transition to the assisted driving mode from a remote driving target vehicle and the transition is possible.

The detailed description of the preferred embodiments of the present disclosure disclosed above has been provided to enable those skilled in the art to implement and practice the present disclosure. Although the present disclosure has been described with reference to the preferred embodiments, those skilled in the art can understand that the present disclosure can be modified and changed in various manners without departing from the scope of the present disclosure. For example, those skilled in the art can utilize components described in the above embodiments in a manner of combining the components.

Therefore, the present disclosure is not intended to be limited to the embodiments shown herein, but is intended to have the widest scope consistent with the principles and novel features disclosed herein.

According to the vehicle communication control device and method of the present disclosure, when autonomous vehicles connected to an autonomous driving service (control) transmit data to a server, the current network status is measured and shared between the vehicles and the control, and the amount of transmitted data is adjusted to maintain the network throughput above a certain level such that autonomous vehicles registered with the service can help maintain a stable network, thereby allowing mobile network communication to be performed all the time.

In addition, according to the embodiments of the present disclosure as described above, it is possible to implement a method of defining operating states of a tele-operated vehicle in consideration of various situations of a remote driving control center in a situation where the tele-operated vehicle transmits a request for remote driving services, and setting an operating state of the tele-operated vehicle accordingly.

Specifically, in defining the operating state of a tele-operated vehicle, when an autonomous vehicle transmits a request for remote driving, an operation mode of the tele-operated vehicle is defined and operated such that the vehicle can be provided with an appropriate remote driving service even when a remote driver in the remote driving control center cannot respond to the request, thereby providing remote driving services without delay.

In addition, by using a standardized control and management method commonly used by remote driving service providers in the remote driving control system, the remote driving control center can efficiently provide remote driving services.

Furthermore, as specific embodiments of the present disclosure, specific scenarios in which the monitoring mode/assistant driving mode/direct driving mode can be utilized are presented, and an operation mode for each scenario and an operation method for each execution entity can be specified.

The effects that can be obtained from the present disclosure are not limited to the effects mentioned above, and other effects that are not mentioned can be clearly understood by a person having ordinary knowledge in the technical field to which the present disclosure belongs from the description below.

The vehicle communication control device and method according to the embodiments of the present disclosure described above can be utilized in various ways as a means for assisting autonomous driving, or separately from autonomous driving.

The above description is merely illustrative of the technical idea of the present disclosure. It will be apparent to those skilled in the art that various modifications and variations can be made in the present disclosure without departing from the spirit or scope of the disclosures.

Therefore, the above detailed description is to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. A remote driving server device for controlling a vehicle capable of remote driving, comprising:
a data decoder configured to decode remote environment data received from a remote driving target vehicle device;
a network delay predictor configured to calculate a network delay time for a network path between the vehicle device and the server device and to transmit information on the network delay time to the vehicle device; and
a remote driving driver's seat configured to generate a remote driving control instruction for the vehicle.

2. The remote driving server device of claim 1, further comprising:
a remote driving ECU configured to receive a remote driving instruction from the remote driving driver's seat and to generate remote driving control information based on the remote driving instruction; and
a transmission unit configured to transmit the remote driving control information to the vehicle device.

3. The remote driving server device of claim 1, wherein the network delay predictor comprises:
a delay time calculation unit configured to receive a probe packet for network status analysis from the vehicle device and to calculate a delay time for a network path between the server device and the vehicle; and
a delay information transmission unit configured to generate network delay information based on the calculated delay time and to transmit the network delay information to the vehicle.

4. The remote driving server device of claim 1, wherein the network delay predictor further comprises:
a control information reception unit configured to receive control information for remote driving; and
a storage configured to store the calculated delay time and the control information.

5. The remote driving server device of claim 1, further comprising an operating state determination unit configured to determine an operating state of the vehicle depending on information on the vehicle,
wherein the operating state determination unit is configured to set any one of a remote driving OFF state and a remote driving ON state.

6. The remote driving server device of claim 5, wherein, based on the operating state determination unit setting the operating state of the vehicle to the remote driving ON state, the operating state of the vehicle is additionally set to any one of:
a monitoring state in which monitoring information on surroundings of the vehicle is collected without involvement in driving of the vehicle;
an assisted driving state in which driving assistance information for the vehicle is provided based on the monitoring information; and
a remote driving state in which a remote driver in a remote driving control center in which the remote driving server device is provided provides a driving control signal to the vehicle.
